(19) United States
(12) Patent Application Publication
(10) Pub. No.: US 2010/0230131 A1
(43) Pub. Date: Sep. 16, 2010

(54) POLYOLEFIN-BASED HIGH DIELECTRIC STRENGTH (HDS) NANOCOMPOSITES, COMPOSITIONS THEREFOR, AND RELATED METHODS

(75) Inventors: Suh Joon Han, Belle Mead, NJ (US); Laurence H. Gross, Bridgewater, NJ (US); Scott H. Wasserman, Morganville, NJ (US)

Correspondence Address: The Dow Chemical Company, P.O. BOX 1967, Midland, MI, 48641, US

(73) Assignee: Union Carbide Chemicals & Plastics Technology LLC (formerly Union Carbide Chemicals & Plastics Techn, Midland, MI (US)

(21) Appl. No.: 12/280,304

(22) PCT Filed: Feb. 26, 2007
(86) PCT No.: PCT/US07/05018

§ 371 Date: Aug. 21, 2008

Related U.S. Application Data
(60) Provisional application No. 60/777,164, filed on Feb. 27, 2006.

(51) Int. Cl. H01B 3/44; C08L 23/06; C08L 23/08; C08L 23/12; C08L 9/00; C08L 23/20

(52) U.S. Cl. 174/110 PM; 524/585; 524/570; 524/582; 524/574; 524/579; 977/774

(57) ABSTRACT

The present invention is a cable having (a) one or more electrical conductors or a core of one or more electrical conductors and (b) each conductor or core being surrounded by a layer of insulation. The insulation layer is prepared from a composition comprising a polyolefin and a 3-dimensional, cage-structured nanoparticle. The preferred polyolefins are polyethylene polymers, and the preferred nanoparticles are polyhedral oligomeric silsesquioxanes (POSS), polyhedral oligomeric silicates (POS), or polyhedral oligomeric siloxanes.

### FIELD OF THE INVENTION

This invention relates to a power cable insulation layer. Specifically, the insulation layer is useful for low to high voltage wire-and-cable applications.

### DESCRIPTION OF THE PRIOR ART

For low to high voltage wire and cable applications, a dielectric should have low dielectric losses and very low electrical conductivity. Additionally, when used as an insulating material, a dielectric must have a very high electrical breakdown withstand capability. The insulation material must also meet certain physical, chemical, and mechanical property requirements.

Accordingly, there is a continuing need for polymer-based insulation layers of power cables and accessories to have excellent dielectric, physical, chemical, and mechanical properties.

### SUMMARY OF THE INVENTION

The present invention is a cable comprising one or more electrical conductors or a core of one or more electrical conductors and having each conductor or core being surrounded by a layer of insulation. The insulation layer was prepared from a composition comprising a polyolefin and a 3-dimensional, cage-structured nanoparticle. The preferred polyolefins are polyethylene polymers, and the preferred nanoparticles are polyhedral oligomeric silsesquioxanes (POSS), polyhedral oligomeric silicates (POS), or polyhedral oligomeric siloxanes.

### DESCRIPTION OF THE INVENTION

“3-Dimensional, cage-structured,” as used herein, means a molecule having a polyhedral structure.

“Dielectric loss,” as used herein, means dissipation factor as measured by parallel plate solid cell tester at 60 Hertz and according to ASTM D150. For example, as used herein and measured at room temperature, a nanocomposite would be stated to demonstrate low dielectric losses when the nanocomposite achieves a dissipation factor that is no more than 0.001 for crosslinked polyethylene composite system, 0.005 for tree retardant crosslinked polyethylene composites system, and 0.02 for ethylene/propylene rubber composites system.

“Electrical breakdown withstand,” as used herein, means alternating current (AC) voltage breakdown strength of composites as measured by an AC breakdown tester with parallel plane electrodes and according to ASTM D149. As used herein, a nanocomposite would be stated to have a very high electrical breakdown capability when the nanocomposite achieves at least 0.9 kiloVolts/mil at room temperature.

“Electrical conductivity,” as used herein, means insulation resistance as measured according to ICEA S68-516. As used herein, a nanocomposite would be stated to have a very low electrical conductivity when the nanocomposite achieves no less than 20,000 mega ohms for 1000 feet at 15.6 degrees Celsius.

“Nanoparticle,” as used herein, means a particle having an average diameter of less than about 1000 nanometers. While the term “diameter” is used herein to describe suitable particle sizes, it should be understood that nanoparticles for use in the present invention need not be substantially spherical in shape. Accordingly, the definition of “diameter” may be applied to nanoparticle such that the average length of the longest line that could theoretically be drawn to bisect the particle is less than about 1000 nanometers.

The invented cable comprises one or more electrical conductors or a core of one or more electrical conductors, each conductor or core being surrounded by a layer of insulation prepared from a composition comprising a polyolefin and a 3-dimensional, cage-structured nanoparticle.

Polyolefins useful in the present invention have a melt index in the range from about 0.1 grams per 10 minutes to about 50 grams per 10 minutes. Melt index is determined under ASTM D-1238, Condition E and measured at 190 degrees Celsius and 2160 grams.

Suitable polyolefins include polyethylene homopolymers, polyethylene copolymers, ethylene/propylene rubbers, ethylene/propylene/diene monomers (EPDM), polypropylene homopolymers, polypropylene copolymers, polybutene, polybutene copolymers, and highly short chain branched α-olefin/ethylene copolymers.

Polyethylene polymer, as that term is used herein, includes homopolymers and copolymer of ethylene and a minor proportion of one or more alpha-olefins having 3 to 12 carbon atoms, and preferably 3 to 8 carbon atoms, and, optionally, a diene, or a mixture or blend of such copolymers. The portion of the polyethylene copolymer attributed to the comonomer(s), other than ethylene, can be in the range of about 1 to about 49 percent by weight based on the weight of the copolymer and is preferably in the range of about 15 to about 40 percent by weight. Examples of the alpha-olefins are propylene, 1-butene, 1-hexene, 4-methyl-1-pentene, and 1-octene. Suitable examples of dienes include ethylidene norbornene, butadiene, 1,4-hexadiene, or a dicyclopentadiene.

The polyethylene polymer can have a density in the range of about 0.850 to about 0.950 grams per cubic centimeter. The polyethylene polymer also can have a melting temperature of at least about 115 degrees Celsius. Preferably, the melting temperature is greater than about 115 degrees Celsius. More preferably, the melting temperature is greater than about 120 degrees Celsius.

Typical catalyst systems for preparing the polyethylene polymer include magnesium/titanium-based catalyst systems, vanadium-based catalyst systems, chromium-based catalyst systems, and other transition metal catalyst systems. Many of these catalyst systems are often referred to as Ziegler-Natta catalyst systems or Phillips catalyst systems. Useful catalyst systems include catalysts using chromium or molybdenum oxides on silica-alumina supports.

Useful catalyst systems may comprise combinations of various catalyst systems (e.g., Ziegler-Natta catalyst system with a metallocene catalyst system). These combined catalyst systems are most useful in multi-stage reactive processes.

Preferably, the polyolefin is a polyethylene prepared by free-radical polymerization in a high-pressure reactor.

The 3-dimensional, cage-structured nanoparticle is preferably present in the composition for preparing the insulation layer in an amount between about 0.1 weight percent to about 40 weight percent of the total composition. Examples of useful 3-dimensional, cage-structured nanoparticles are polyhedral oligomeric silsesquioxanes (POSS), polyhedral oligomeric silicates (POS), polyhedral oligomeric siloxanes, and other nanoparticles useful in constructing organic/inorganic nanocomposites. Other useful 3-dimensional, cage-structured nanoparticles include those nanoparticles which provide a high interfacial interaction between the polyolefin and the nanoparticles.

The 3-dimensional, cage-structured nanoparticle can have reactive functional group, nonreactive functional groups, or both reactive and nonreactive functional groups. When the nanoparticles are POSS, POS, or polyhedral-oligomeric-siloxane nanoparticles, the functional group can be a hydroxyl, carboxylic, amine, epoxide, silane, or vinyl group. The functional group can be useful for compatibilization of the nanoparticles in the insulation composition or with certain components in the composition, including the polyolefin. Other functional groups can be useful for grafting or carrying out other chemical reactions within the composition.

The insulation composition can further comprise other nanoparticles, antioxidants, curatives, processing aids, anti-blocking agents, anti-stick slip agents, catalysts, stabilizers, scorch retarders, water-tree retarders, electrical-tree retarders, colorants, corrosion inhibitors, lubricants, flame retardants, and nucleating agents. These additional components can preferably be present in an amount between 0.1 weight percent to about 10 weight percent. Examples of additional nanoparticles include silica particles or metallic oxides. Suitable metallic oxides include zinc oxide, titanium oxide, magnesium oxide, and aluminum oxides.

The composition for preparing the insulation layer may be crosslinkable or thermoplastic.

What is claimed is:

1. An insulation composition comprising:
(a) a polyolefin and
(b) a 3-dimensional, cage-structured nanoparticle.

2. The insulation composition according to claim 1 wherein the polyolefin is selected from the group consisting of polyethylene homopolymers, polyethylene copolymers, ethylene/propylene rubbers, ethylene/propylene/diene monomers (EPDM), polypropylene homopolymers, polypropylene copolymers, polybutene, polybutene copolymers, and highly short chain branched α-olefin/ethylene copolymers.

3. The insulation composition according to claim 1 wherein the 3-dimensional, cage-structured nanoparticle is selected from the group consisting of polyhedral oligomeric silsesquioxanes (POSS), polyhedral oligomeric silicates (POS), and polyhedral oligomeric siloxanes.

4. The insulation composition according to claim 3 wherein the 3-dimensional, cage-structured nanoparticle is present in an amount between about 0.1 weight percent to about 40 weight percent of the total composition.

5. An electrical cable comprising one or more electrical conductors or a core of one or more electrical conductors, wherein each conductor or core being surrounded by a layer of insulation prepared from a composition comprising:
(a) a polyolefin and
(b) a 3-dimensional, cage-structured nanoparticle.

6. The electrical cable according to claim 5 wherein the polyolefin is selected from the group consisting of polyethylene homopolymers, polyethylene copolymers, ethylene/propylene rubbers, ethylene/propylene/diene monomers (EPDM), polypropylene homopolymers, polypropylene copolymers, polybutene, polybutene copolymers, and highly short chain branched α-olefin/ethylene copolymers.

7. The electrical cable according to claim 5 wherein the 3-dimensional, cage-structured nanoparticle is selected from the group consisting of polyhedral oligomeric silsesquioxanes (POSS), polyhedral oligomeric silicates (POS), and polyhedral oligomeric siloxanes.
